(19) United States
(12) Patent Application Publication
(10) Pub. No.: US 2025/0257236 A1
(43) Pub. Date: Aug. 14, 2025

(54) PRIMERS FOR DIGITAL PRINTING

(71) Applicant: SUN CHEMICAL B.V., Weesp (NL)

(72) Inventors: Joanne GUITE, Rochdale, Lancashire (GB); Harvey HARPHAM, Rochdale, Lancashire (GB)

(73) Assignee: SUN CHEMICAL B.V., Weesp (NL)

(21) Appl. No.: 19/101,862

(22) PCT Filed: Sep. 29, 2023
(86) PCT No.: PCT/GB2023/052527

§ 371 Date: Feb. 6, 2025

(30) Foreign Application Priority Data
Oct. 7, 2022 (GB) 2214770.6

(51) Int. Cl. C09D 11/54; B41M 5/00; B41M 7/00; C09D 11/104; C09D 11/107

(52) U.S. Cl. CPC C09D 11/54; B41M 5/0017; B41M 5/0064; B41M 7/0027; C09D 11/104; C09D 11/107

(57) ABSTRACT

An aqueous primer composition comprising: (i) a polymer dispersion selected from an acrylic dispersion, polyester urethane dispersion, and blends thereof; and (ii) an aminated polymer, wherein the aminated polymer is poly(ethylene imine) and wherein the poly(ethylene imine) is present from 0.5 to 25% (w/w).

The present invention provides an aqueous primer composition suitable for use in digital printing of plastic substrates. The aqueous primer compositions of the invention are particularly suitable for printing of plastic cores of payment and financial cards followed by the thermal lamination of the printed surface with further plastic layers. Advantageously, the resulting plastic laminates have reduced dye leaching.

The present invention also provides a process for preparing digitally printed laminates and laminates prepared by said process.

U.S. Pat. No. 11,066,781 (Eastern Tech) refers to a textile pretreatment for inkjet printing comprising greater than 40% (w/w) of a multivalent salt combined with up to 5% (w/w) of a blocked isocyanate and up to 40% (w/w) of an aqueous binder, which may be a polyurethane dispersion (‘PUD’). Such high concentrations of metal salts make these primers unsuitable for the lamination process of the invention and furthermore, printing via digital electrophotographic printing, such as that of HP Indigo, is not revealed.

U.S. Pat. No. 6,761,940 (Hueck Folien), without providing any illustrative examples, refers to a primer comprising a thermoplastic polymer which may further comprise a crosslinker. The thermoplastic polymer of the primer is preferably a copolymer of ethylene with an acrylate monomer. Reference to printing via the HP Indigo electrophotographic digital process is made. U.S. Pat. No. 6,761,940 does not refer to the use of a polymer dispersion along with an aminated polymer crosslinker according to the present invention.

The HP Indigo process uses what are termed ‘Electroinks’, which are essentially pigment dispersions in a carrier comprising paraffinic solvents and an ethylene copolymer (with comonomers selected from methacrylic acid and acrylic acid). They tend to have deficient adhesion to plastic substrates and have poor heat resistance. The thermoplastic nature of the ethylene copolymer binder can result in a distortion of the print with a consequent loss in print quality. The present invention helps overcome these issues; namely poor adhesion and poor lamination bond strengths along with maintaining print quality during high temperature processing of such prints, including the thermal lamination process encompassed by the invention. The present invention also overcomes problems of dye leaching.

The inks used in the HP Indigo process (commonly referred to in the art as liquid toner inks) incorporate thermoplastic polymers, such as copolymers of ethylene with methacrylic acid or acrylic acid. A number of primers encompassing such copolymers for the subsequent printing with liquid toners via electrophotographic printing have been referred to in the prior art. U.S. Pat. No. 7,470,736 (Michelman) and WO 2020/190723 (Sun Chemical) refer to aqueous primer compositions comprising copolymers of ethylene and acrylic acid (or methacrylic acid) along with a polyurethane dispersion. Although suitable as print receptive primers for digital printing, without the additional crosslinker present in the primers of the present invention they will not maintain the print quality and enable good lamination bond strengths during thermal lamination.

U.S. Pat. No. 9,639,011 (HP) refers to a solvent-based primer for electrophotographic digital printing comprising a copolymer of ethylene and methacrylic or acrylic acid. This primer was applied via electrophotographic printing prior to printing with pigmented liquid toners (‘HP Electrink’). The issues of adhesion, print quality maintenance during thermal lamination and the delivery of good thermal bond strengths were not discussed.

U.S. Pat. No. 10,564,562 (HP) takes this concept further through the application of an analog first-down aqueous primer, ‘Digiprime 050’, ex. Michelman, prior to a digitally applied primer along the lines disclosed in U.S. Pat. No. 9,639,011.

U.S. Pat. No. 10,851,262 (Sun Chemical) refers to an analog applied primer for digital printing, especially liquid electrophotographic digital printing (‘LEP’). The primer, which comprises a blend of a polyurethane dispersion along with a self-crosslinking acrylic dispersion improves the adhesion and block resistance of prints to a range of substrates.

U.S. Pat. No. 10,301,478 (Ashland) refers to a primer coating, especially for LEP printing, comprising a cationic polyurethane dispersion along with either a polyoxazoline or N-vinyl pyrrolidone copolymer. The use of any crosslinker is not disclosed.

WO 2021/011606 (Michelman) refers to an aqueous primer coating comprising a multivalent metal salt and an amine-containing polymer suitable for digital printing via electrophotographic and inkjet processes. A thermal lamination process according to the present invention is not disclosed.

The use of digital printing techniques, such as powder and liquid electrophotographic printing and inkjet printing has grown significantly over recent years. Digital printing is now penetrating into many of the markets traditionally served by analog printing processes (flexo, gravure, offset, screen printing, etc.). These markets include, for example graphics, packaging, corrugated, textiles, ceramics, commercial printing, etc. Some of the benefits associated with digital printing include on-demand printing, personalization, variable data printing, reduction of stored printed stock.

The Hewlett-Packard Company's ‘HP Indigo’ liquid electrophotographic printing process has been successfully commercially implemented in a wide range of printing applications, including the printing of labels and narrow web packaging. In this process, the liquid toner images are formed on a photosensitive drum and electrostatically transferred onto a heated intermediate blanket prior to printing on a web or sheet substrates. Descriptions of this technology are provided in U.S. Pat. Nos. 4,794,651 and 5,407,771. Such liquid toners produce prints often deficient in adhesion to plastic substrates in particular and can also lack physical robustness, therefore requiring the use of protective overprint lacquers in some applications. Furthermore, and an issue addressed by the current invention, the prints produced by such liquid electrophotographic printing may not produce laminates with sufficient bonding strength to allow the laminates to meet the technical requirements. The laminated prints produced by liquid electrophotographic printing (such as the ‘HP Indigo’ printing process) are also prone to dye leaching. The primer according to the present invention addresses the problem of dye leaching by fixing the dye to the substrate. The problem of dye leaching has not been identified in the prior art.

Citation or identification of any document in this application is not an admission that such represents prior art to the present invention.

### DETAILED DESCRIPTION

The current invention enables plastic laminates to be produced, which have been printed using liquid electrophotographic toners and subsequently thermally laminated to second or further plastic plies, which do not exhibit dye leaching. The invention is preferably directed towards the printing of the plastic cores of payment and financial cards followed by the thermal lamination of the printed surface with further plastic layers. Most particularly, the invention is directed towards the printing of vinyl chloride or vinylidene dichloride homopolymers and copolymers containing banking card cores, prior to the thermal lamination of further plastic plies which may also comprise vinyl chloride or vinylidene dichloride homopolymers and copolymers.

Thermal lamination is the process where a second plastic film is brought into contact with the printed surface of the card core and then subjected to high temperatures (typically in excess of 100° C., and more usually in excess of 120° C.) and pressure (typically in excess of 50 bar, and up to 200 bar) to form the bonded laminate. Without the primer of the present invention not only do card cores printed with liquid electrophotographic fluids lack the necessary laminate bond strength they are also subject to a loss of print quality during thermal lamination and dye leaching. This loss of print quality results from the ink ‘moving’ during the thermal lamination. Similarly, dye leaching results from internal dye movement during thermal lamination. The inventors do not wish to be bound to any theory behind this loss of print quality or dye leaching but postulate that it is due, in part, to the thermoplastic nature of the polymer binder of toner which softens and deforms during lamination.

Primers according to the present invention help overcome deficiencies related to adhesion and lamination bond strength along with maintenance of print quality. The primers according to the present invention also prevent dye leaching. This is achieved through using an appropriate polymer dispersion and aminated polymer crosslinking agent. Again, the inventors do not want to be bound by any theory but postulate that after printing, a part of the crosslinker migrates from the primer into the ink such that when the print is laminated both the primer and ink crosslink to maintain the print quality. Moreover, the inventors postulate that after printing, a part of the crosslinker migrates from the primer into the ink and fixes the dye to the substrate thereby preventing leaching.

The prior art does not disclose use of a print receptive primer according to the present invention, especially for electrophotographic (toner) printing, in the manufacture of payment and financial cards. A number of instances in the background references describe primers for electrophotographic printing comprising polymer dispersions, but without the essential crosslinker (a poly(ethylene imine)) which is key to the process of the present invention.

Print receptive primers for digital printing and especially by electrophotographic printing having a crosslinking agent which is activated during thermal lamination have not been disclosed. Without the crosslinker there is a loss in print quality during the thermal lamination to form finished payment and financial cards and also the incorporation of the crosslinking agent results in significantly stronger laminate bond strengths than would be achieved without its use.

The benefits of printing onto a thermoplastic primer to ensure good print receptivity followed by a curing reaction activated by the high temperatures of thermal lamination to ensure print quality maintenance during that lamination and good laminate bond strengths has not been anticipated by the prior art. Moreover, the use of a primer composition according to the present invention to prevent dye leaching after thermal lamination is not disclosed in the prior art.

The present invention relates to an aqueous primer composition comprising: (i) a polymer dispersion selected from an acrylic dispersion, a polyester urethane dispersion or blends thereof; and (ii) an aminated polymer, wherein the aminated polymer is poly(ethylene imine) and wherein the poly(ethylene imine) is present from 0.5 to 25% (w/w). Preferably, the aqueous primer composition (also referred to as a print receptive primer) is applied to a substrate via flexography, gravure or screen printing. The primer can then be overprinted with one or more digital inks. Preferably, overprinting is via digital electrophotographic (toner) printing.

Although primarily directed towards aqueous print receptive primers for overprinting via digital electrophotographic (toner) printing the primers of the invention are also suitable for overprinting via inkjet printing and especially for aqueous inkjet printing inks (i.e., overprinting with aqueous inkjet printing inks via inkjet printing).

The aqueous print receptive primers comprising poly(ethylene imine) as a crosslinking agent according to the present invention are suitable for curing at temperatures above 80° C. after being overprinted via electrographic (toner) or inkjet digital printing processes are described. Preferably, the primers are applied by flexography, gravure or screen printing methods.

In a preferred application, the primers of the present invention are used in the manufacture of payment and financial cards (such as credit cards, bank cards and the like) where the primer is applied to the core of the card, digitally printed upon, then thermally laminated to second and possibly further plastic plies. For the manufacture of payment and financial cards the primers of the invention ensure that print quality is maintained during the thermal lamination process and also ensure that the bonding strength between the primed and digitally printed core and the succeeding plastic layers of the final card are preferably in excess of 7N after being aged for 2 weeks at 55° C. and 93% relative humidity. The bond strengths can be measured using a JJ Lloyd bond strength tester and preferably the minimum bond strength is ≥7N/cm, more preferably ≥10N/cm, even more preferably ≥15N/cm, even more preferably still ≥17N/cm or most preferably ≥20N/cm. The primers of the invention also prevent dye leaching.

The problem of dye leaching is solved by using aqueous primer coating compositions comprising a polymer dispersion together with a polyethylene imine as an aminated polymer crosslinking agent. In particular, the problem of dye leaching is solved by using aqueous primer coating compositions comprising a polymer dispersion selected from an acrylic dispersion, polyester urethane dispersion, and blends thereof together with 0.5 to 25% (w/w) poly(ethylene imine). After printing, the primer becomes crosslinked during the thermal lamination to form the finished card. It is conceivable that some of the crosslinker in the primer migrates into the ink so that both become crosslinked during lamination. Without the crosslinker there may be a loss in print quality and the laminate bond strengths may be weaker than is achieved with its inclusion. Furthermore, without the crosslinker there is dye leaching from the ink.

The inventive primers allow the manufacture of digitally printed payment and financial cards (and also identity cards). This is highly beneficial allowing for the advantages associated with digital printing, such as variable data, personalization, on-demand printing and even the printing of individual security features to be realized. The inventors have shown that it is the use of the primers according to the invention that is key in ensuring that print quality is maintained, and good laminate bond strengths are achieved when the primed and printed core of the card is thermally laminated to further plastic plies at temperatures in excess of 100° C. The use of the inventive primers is also key to preventing dye leaching.

These significant advantages conferred by the invention allow for the digital printing production of payment and financial cards which is not currently possible.

Furthermore, the invention enables a market desired shift from analog to digital printing of such cards.

The primer according to the invention is applied first to the plastic card core, dried and then printed digitally to produce the desired image and information before the printed core is thermally laminated to further plastic layers and subjected to any other production processes such as the inclusion of holograms and the like.

After the substrate (e.g., card core) is coated with the inventive primer it may be subsequently overprinted by any digital process including liquid electrographic (toner) printing, dry electrographic (toner) printing and inkjet printing. For inkjet printing the invention is especially suited to the printing with aqueous inkjet printing inks but also allows for the printing with UV, and energy-curable inkjet printing inks and solvent-based inkjet printing inks. However, the invention is especially suited to liquid electrographic (toner) printing, such as Hewlett Packard's ‘HP Indigo’ process.

The aqueous primer according to the invention comprises a polymer dispersion selected from an acrylic dispersion, a polyester urethane dispersion (e.g., a non-ionic polyester urethane dispersion) and blends thereof.

The primer according to the invention also comprises an animated polymer crosslinking reagent, which is poly(ethylene imine). The poly(ethylene imine) may have a linear or branched structure, although a branched structure is preferred. As will be understood, poly(ethylene imine) has amine functionality on the polymer backbone. Where the poly(ethylene imine) is branched, it may also have amine functionality on pendant side-chains in addition to on the polymer backbone. Preferably, the poly(ethylene imine) is branched and has amine functionality on the polymer backbone and on pendant side-chains.

The primers of the invention may optionally also comprise a further aminated polymer such as a poly(vinyl amine), copolymers of vinyl amine, aminated starches, amine functional poly(ethylene glycol), amine functional poly(propylene glycol) and blends thereof.

A suitable commercially available poly(ethylene imine) that can be used in the present invention is Loxanol MI 6735 (BASF).

The poly(ethylene imine) may have an average molecular weight of ≥10,000 g/mol, for example from about 10,000 g/mol to about 50,000 g/mol. Preferably, the poly(ethylene imine) may have an average molecular weight of from about 20,000 g/mol to about 40,000 g/mol, more preferably from about 20,000 g/mol to about 30,000 g/mol.

The primers of the invention may optionally also comprise a further crosslinking reagent such as thermally activated blocked isocyanates, polycarbodiimides (for example, Carbodilite, ex. Nisshinbo); oxazoline-functional polymer crosslinkers (e.g., Epocros, ex. Nippon Shokubai); melamine-formaldehydes (for example, Maprenal, ex. Incos Melamines); zinc ammonium carbonate solutions; zinc oxide nanoparticles (for example Oxylink, ex. Buhler.

The primers of the invention may optionally further comprise a thermally blocked isocyanate. Where used, the thermally blocked isocyanate is preferably present in an amount of 0.5 to 5 wt % of the primer composition.

As will be understood in the art, blocked isocyanates are a class of crosslinker where the reactive isocyanate groups of the crosslinker have been reacted with a suitable blocking agent. Hence, thermally activated blocked isocyanate crosslinking agents are blocked isocyanates that can be unblocked (i.e., activated) upon heating, for example at temperatures of greater than 80° C. Typically, thermally activated blocked isocyanate crosslinking agents are unblocked (i.e., activated) at 90 to 200° C., preferably 100 to 180° C. Examples of blocking agents along with their typical unblocking temperatures are diethyl malonate (‘DEM’; 100 to 120° C.), 3,5-dimethylpyrazole (‘DMP’; 110 to 120° C.), methylethylketoxime (‘MEKO’; 140 to 160° C.) and caprolactam (160 to 180° C.). Such blocked isocyanates which may be difunctional, trifunctional, tetrafunctional or higher functional with respect to the number of isocyanate groups per molecule allow the preparation of stable one-pack crosslinkable compositions and are used in a number of applications, including automotive coatings and textiles inks. The blocked isocyanate crosslinkers used in the preparation of the primers of the invention are advantageously water-based. Trixene BI220 (ex. Lanxess) was used in the preparation of the examples. The blocking group used in the preparation of Trixene BI220 is DMP, and as such allows unblocking at temperatures typical of those used in the thermal lamination production of payment and financial cards, such as 120 to 160° C. Blocked isocyanates are available from a number of suppliers including Lanxess (‘Trixene’), Covestro (‘Imprafix’), Aquaspersions (‘Aqualink’), Rudolf GmbH (‘Rucopud’), Evonik (‘Vestanat’).

In an alternative embodiment of the invention, the primer composition is preferably free of further crosslinking reagents such as thermally activated isocyanates, polycarbodiimides, oxazoline-functional polymer crosslinkers, melamine-formaldehydes, zinc ammonium carbonate solutions, zinc oxide nanoparticles. For instance, in an alternative preferred embodiment, the primer is free of thermally activated blocked isocyanates.

The primer composition comprises from 0.5 to 25% (w/w) of poly(ethylene imine), preferably from 0.5 to 20% (w/w), more preferably from 0.5 to 15% (w/w).

The crosslinker may form, on dry weight, from 0.5 to 25% of the primer composition; preferably from 0.5 to 20%, more preferably from 0.5 to 15%.

Preferably, the polymer of said polymer dispersion forms, on dry weight, from 2.5 to 99.5% (w/w) of the primer composition, preferably from 10.0 to 98%; more preferably from 20.0 to 95%.

Preferably, the primer according to the present invention comprises a polyester urethane dispersion. Anionic, cationic and non-ionic polyester urethane dispersions may be used, although non-ionic polyester urethanes are preferred. A suitable commercially available polyester urethane dispersion that can be used in the present invention is NeoRez R-9340 from Cavestro. The polyester urethanes may be aromatic and aliphatic.

Preferably, the primer composition according to the present invention comprises a polyester urethane dispersion and 0.5% to 25% (w/w) poly(ethylene imine), preferably 0.5% to 15% (w/w) poly(ethylene imine), more preferably 0.5% to 8% (w/w) poly(ethylene imine).

Alternatively, the primer according to the present invention preferably comprises an acrylic dispersion. Anionic, cationic and non-ionic acrylic dispersions may be used, although non-ionic acrylic dispersions are preferred. A suitable commercially available acrylic dispersion that can be used in the present invention is Alberdingk EP 124181 from Alberdingk-Boley.

Preferably, the acrylic dispersion is an acrylic homopolymer dispersion. As will be understood in the art, a homopolymer comprises at least 95 mol % of a single monomer unit, preferably at least 98 mol % of a single monomer unit, more preferably at least 99.5 mol % of a single monomer unit. For example, an acrylic homopolymer typically comprises at least 95 mol % of an acrylic monomer, preferably at least 98 mol % of an acrylic monomer, more preferably at least 99.5 mol % of an acrylic monomer. As used herein, unless stated otherwise, the acrylic monomers that make up the acrylic homopolymer can be acrylic acid or methacrylic acid. For example, an acrylic homopolymer may include polymers comprising at least 95 mol % of monomer units derived from acrylic and/or methacrylic acid, although homopolymers comprising at 95 mol % of monomer units derived from acrylic acid are preferred. As will be understood in the art, ethylene acrylic acid copolymers comprising less than 95 mol % of acrylic monomers are not acrylic homopolymers. Preferably, the primer composition according to the present invention does not comprise any ethylene acrylic acid copolymers (i.e., ethylene acrylic acid copolymers comprising less than 95 mol % of acrylic monomers).

Preferably, the primer composition according to the present invention comprises an acrylic dispersion and 0.5% to 25% (w/w) poly(ethylene imine), preferably 1% to 20% (w/w) poly(ethylene imine), more preferably 3% to 15% (w/w) poly(ethylene imine).

Alternatively, the primer composition according to the invention preferably comprises an acrylic dispersion and a polyester urethane dispersion.

The primer according to the present invention may optionally further comprise a polyurethane dispersion (‘PUD’) wherein the polyurethane is prepared from polyether diols, polyacrylic diols or polycarbonates. For instance, the primer composition may comprise a polyurethane prepared from a polyether diol (i.e., a polyether urethane). A suitable polyether urethane is Rheolate 278 available from Elementis. Where used, the additional polyether urethane is present in 0.01 to 5 wt % of the primer composition. Typically, the additional polyether urethane is used as a thickener in order to achieve a desired viscosity.

Anionic, cationic and non-ionically stabilized PUDs are encompassed by the invention as are aromatic and aliphatic PUDs.

Where the primer composition of the present invention further comprises a PUD prepared from polyether diols, polyacrylic diols or polycarbonates, anionic PUDs may be used, especially those that are commonly produced by the inclusion of a carboxylic acid into the polymer structure of the PUD for example by the urethane reaction of dimethylol propionic acid (‘DMPA’). Where DMPA, or other acid-containing species, is incorporated into the PUD backbone then it may be neutralized with any organic or inorganic base to provide the anionic stabilizing mechanism. These various resin types may, where applicable, be neutralized using organic bases, including (but not limited to) ammonia, triethanolamine, triisopropanolamine, dimethyl aminoethanol, N-methyldiethanolamine or arginine. Alternatively, they may be neutralised by an inorganic base including (but not limited to) alkali metal oxides, alkali metal hydroxides or alkali metal carbonates, sodium hydroxide, and potassium hydroxide.

There are a variety of commercially available PUDs that can be used in the invention including those sold under the trademarks Neorez (DSM), Bayhydrol (Covestro), Sancure (Lubrizol), Syntegra (Dow), Luplen (BASF), Beetafin (BIP), Daotan (Allnex), and those supplied under the ‘U’ nomenclature from Alberdingk-Boley.

Typically, the polymer dispersions used in the present invention have a solids content of from 20 to 50%, preferably from 25 to 45%.

The aqueous primers of the invention may also optionally further comprise any ionic or non-ionic styrene-acrylic dispersion. Suitable styrene-(meth)acrylic resin dispersions are widely available commercially and include those sold under the trade names Joncryl (BASF), Revacryl (Synthomer), Hycar (Lubrizol), Neocryl (DSM), Neboplast (Necarbo), and the Picassian AC range (Picassian Polymers). It should be understood that this is not a limiting list and those skilled in the art should appreciate that any other styrene-(meth)acrylic resin dispersion could be used.

The aqueous primers of the invention may also optionally further comprise any solution polymer (also referred to as an alkali-soluble polymer) including alkali-soluble acrylic and styrene-acrylic polymers. As will be understood, an alkali-soluble polymer typically refers to a polymer usually comprising acid moieties as part of the monomer blend, which can be neutralized with a suitable base including but not limited to ammonia, amines (e.g., triethylamine or triethanolamine) or inorganic bases (e.g., NaOH, KOH) to form polymers that can be dissolved in water to form an aqueous solution. Where alkali-soluble acrylic or styrene-acrylic polymers are used they include those that comprise any of acrylic acid, methacrylic acid, maleic anhydride, itaconic acid, along with any blend of ethylenic, acrylic or methacrylic monomers including (but not limited) to styrene, methyl methacrylate, butyl acrylate, butyl methacrylate, ethyl acrylate, ethyl methacrylate, ethylhexyl acrylate, ethylhexyl methacrylate. Aqueous solutions of these acrylic polymers are formed by neutralising the carboxylic acid groups of the polymer with any base, including (but not limited) to ammonia, trimethylamine, triethanolamine, sodium hydroxide, potassium hydroxide, whilst dissolving the polymer in water.

The primer according to the present invention may optionally further comprise a multivalent metal salt. If a multivalent metal salt is present, it is preferably present in less than 20% (w/w), more preferable less than 10% (w/w), even more preferably less than 5% (w/w). Suitable multivalent metal salts include (but are not limited to) multivalent cationic salts such as calcium nitrate (and hydrates thereof), calcium ammonium nitrate, calcium acetate and calcium chloride. Preferably, the primer according to the present invention comprises less than 20% (w/w) of calcium nitrate (and hydrates thereof), calcium ammonium nitrate, calcium acetate or calcium chloride, more preferable less than 10% (w/w) of calcium nitrate (and hydrates thereof), calcium ammonium nitrate, calcium acetate or calcium chloride, even more preferably less than 5% (w/w) of calcium nitrate (and hydrates thereof), calcium ammonium nitrate, calcium acetate or calcium chloride.

Alternatively, the primer according to the present invention is substantially free of a multivalent metal salt, i.e., the primer comprises less than 1% (w/w) of a multivalent metal salt. Thus, in an alternate preferred aspect of the invention, the primer comprises less than 1% (w/w) of calcium nitrate (and hydrates thereof), calcium ammonium nitrate, calcium acetate or calcium chloride. In a more preferred alternative aspect of the invention, the primer does not contain any (i.e., is free of) calcium nitrate, calcium ammonium nitrate, calcium acetate or calcium chloride. Preferably, the primer does not contain any (i.e., is free of) multivalent metal salts.

The primer composition according to the present invention includes water. Advantageously, the water would not contain ionic impurities. In one embodiment, the water would be ion exchanged or distilled water. In one embodiment, the quantity of water used according to the present invention, including that which is supplied as part of the raw materials used, would be from 20 to 80%, preferably from 30 to 70% by mass according to the entire composition.

The primers may also optionally include any co-solvent, including but not limited to; ethanol, propanol, butanol, acetone, propylene glycol, glycerol, glycol ethers.

The primers may also optionally comprise any number of additives including, but not limited to surfactants, wetting aids, antifoams, de-aerators, biocides. Suitable additives are described herein, but it should be understood that the invention is not limited to those additives.

The primers may also optionally comprise any dispersion of an inorganic material, including but not limited to silica, alumina and clay.

Preferably, the primer composition has a total solid content of from 5.0 to 60.0% (w/w), and more preferably from 5.0 to 40.0% (w/w).

The primers may be suitable for application by any suitable printing or coating method including, but not restricted to flexographic printing, gravure printing, screen printing, roller coating, spray coating. In one embodiment, flexographic and screen printing would be the deposition methods.

Since primers of the current invention are primarily water-based in nature, they may also include a biocide or anti-mold agent. Suitable examples include products based on the following biocide structural types: benz-isothiazolinone, bromo-nitro-propane-diol, isothiazolinone, ethylenedioxydimethanol, or iodo-propynyl butyl carbamate, which are marketed under the trade names Intercide (Akcros Chemicals) or Nipacide (Clariant). Other types of biocide that could be considered include sodium dehydroacetate (Geogard 111S from Lonza), sodium benzoate (Vancide 51 from R. T. VANDERBILT), sodium pyridinethiol-1-oxide (Sodium Omadine from Arch Chemicals), sodium salt of o-phenylphenol (Dowicide A from DOW Chemical) and ethyl p-hydroxybenzoate (Nipastat Sodium from Aako). These are typically used at an amount of from 0.01 to 1.00% by mass in the primer composition.

Defoamers can also optionally be included in the formulation; these prevent the formation of foam during manufacture of the primer and also while printing. Defoamers are particularly important with recirculating printheads. Examples of suitable defoamers include TEGO FOAMEX N, FOAMEX 1488, 1495, 3062, 7447, 800, 8030, 805, 8050, 810, 815N, 822, 825, 830, 831, 835, 840, 842, 843, 845, 855, 860, and 883, TEGO FOAMEX K3, TEGO FOAMEX K7/K8 and TEGO TWIN 4000 available from Evonik. Available from BYK are BYK-066N, 088, 055, 057, 1790, 020, BYK-A 530, 067A, and BYK 354. The additives DC62, DC65, DC 68, DC71 and DC74 are available from Dow Corning. Agitan 120, 150, 160, 271, 290, 298, 299, 350, 351, 731, 760, 761, and 777 are available from Munzing. Surfynol 104PA, AD01, DF-110, DF-58, DF-62, DF-66, DF-695, DF-70, and MD-20 are available from Air Products.

Surface control additives may optionally be used to control the surface tension of the primer to give the desired spread and wetting on the substrate. They can also be used to control the level of slip and scratch resistance of the coating. Examples of suitable surface control additives include but are not limited to TEGO FLOW 300, 370, and 425, TEGO GLIDE 100, 110, 130, 406, 410, 411, 415, 420, 432, 435, 440, 482, A115, and B1484, TEGO GLIDE ZG 400, TEGO RAD 2010, 2011, 2100, 2200N, 2250, 2300, 2500, 2600, 2650, and 2700, TEGO TWIN 4000 and 4100, TEGO WET 240, 250, 260, 265, 270, 280, 500, 505, and 510 and TEGO WET KL245, all available from Evonik. Available from BYK are BYK 333 and 337, BYK UV 3500, BYK 378, 347 and 361, BYK UV 3530 and 3570, CERAFLOUR 998 and 996, NANOBYK 3601, 3610, and 3650, and CERMAT 258. Available from Cytec are EBECRYL 350 and 1360, MODAFLOW 9200, and EBECRYL 341. From Sartomer the aliphatic silicone acrylate CN9800 may be used. Surfynol 104, 420, 440, 465, 485, 61, 82, and 2502 are available from Air Products. Multiwet BD, EF, SU, SO, and VE are available from Croda. Capstone FS-30, 31, 34, 35, 50, 51, 60, 61, 63, 64, 65, and 3100 are available from Du Pont. Also suitable for use are the non-ionic Hydropalat range from BASF.

Included in the primer can optionally be a suitable de-aerator to prevent the formation of air inclusions and pinholes in the dried coating which could affect the primer's performance. Examples include the following products available from Evonik: TEGO AIREX 900, 910, 916, 920, 931, 936, 940, 944, 945, 950, 962, 980 and 986.

Preferably, the aqueous primer of the invention is colorless. Alternatively, the aqueous primer may also comprise one or more colorant(s), including pigments and/or dyes. Examples of suitable organic or inorganic pigments include carbon black, zinc oxide, titanium dioxide, phthalocyanine, anthraquinones, perylenes, carbazoles, monoazo and disazobenzimidazoles, rhodamines, indigoids, quinacridones, diazopyranthrones, dinitroanilines, pyrazoles, diazopyranthrones, pyrazoles, dianisidines, pyranthrones, tetracholoroisoindolines, dioxazines, monoazoacrylides and anthrapyrimidines. The dyes include but are not limited to azo dyes, anthraquinone dyes, xanthene dyes, azine dyes, combinations thereof and the like.

Commercial organic pigments classified according to Color Index International may be used, including, but not limited to, those according to the following trade designations: blue pigments PB1, PB15, PB15:1, PB15:2, PB15:3, PB15:4, PB15:6, PB16, PB60; brown pigments PB5, PB23, and PB265; green pigments PG1, PG7, PG10 and PG36; yellow pigments PY3, PY14, PY16, PY17, PY24, PY65, PY73, PY74 PY83, PY95, PY97, PY108, PY109, PY110, PY113, PY128, PY129, PY138, PY139, PY150, PY151, PY154, PY156, PY175, PY180 and PY213; orange pigments PO5, PO15, PO16, PO31, PO34, PO36, PO43, PO48, PO51, PO60, PO61 and PO71; red pigments PR4, PR5, PR7, PR9, PR22, PR23, PR48, PR48:2, PR49, PR112, PR122, PR123, PR149, PR166, PR168, PR170, PR177, PR179, PR190, PR202, PR206, PR207, PR224 and PR254: violet pigments PV19, PV23, PV32, PV37 and PV42; black pigments PBk1, PBk6, PBk7, PBk8, PBk9, PBk10, PBk11, PBk12, PBk13, PBk14, PBk17, PBk18, PBk19, PBk22, PBk23, PBk24, PBk25, PBk26, PBk27, PBk28, PBk29, PBk30, PBk31, PBk32, PBk33, PBk34, PBk35, NBk1, NBk2, NBk3, NBk4, NBk6; combinations thereof, and the like.

The pigments are milled to less than 1 micrometer after milling with a particle size distribution of 10-500 nm, or 10-350 nm to have better transparency and a wide color gamut.

In order to incorporate the above-described pigments into the inventive compositions, the pigments may be manufactured and stably stored as a pigment concentrate in water. This is typically achieved by dispersing the pigment into a water-soluble or water-dispersible resin using a water-soluble and/or a water-dispersible surfactant which introduces hydrophilic functional groups into the surface of the pigment particles. Examples of these dispersing resins are numerous and could include polyvinyl alcohols, polyacrylic acid, acrylic acid-acrylonitrile copolymers, vinyl acetate-acrylate copolymers, acrylic acid-acrylate copolymers, styrene-acrylic acid copolymers, styrene-methacrylic acid copolymers, styrene-methacrylic acid-acrylate copolymers, styrene-alpha methyl styrene-acrylic acid copolymers, styrene-alpha methyl styrene-acrylic acid-acrylate copolymers, styrene-maleic acid copolymers, styrene-maleic anhydride copolymers, vinyl naphthalene-acrylic acid copolymers, vinyl naphthalene-maleic acid copolymers, vinyl acetate-maleate copolymers, vinyl acetate-crotonic acid copolymers, and vinyl acetate-acrylic acid copolymers, and the salts thereof. The copolymers can be used in any form of random copolymer, block copolymer, alternating copolymer and graft copolymer. Examples of such resins include Joncryl 67, 678, 8500, 586, 611, 680, 682, 683 and 69 available from BASF. Examples of the salts include sodium hydroxide, potassium hydroxide and salts of basic compounds such as ammonia, ethylamine, diethanolamine, triethanolamine, propylamine, isopropylamine, dipropylamine, butylamine, isobutyl amine, diethanolamine, triethanolamine, triisopropanolamine, dimethyl ethanolamine, amino methyl propanol, and morpholine. The amount of the basic compound is not strictly limited as long as the resin dispersant is equal to or more than the neutralization equivalent.

Examples of surfactants used for preparing the pigment dispersion include anionic surfactants such as alkane sulphonates, alpha-olefin sulphonates, alkyl benzene sulphonates, alkyl naphthalene sulphonates, acyl methyl taurinates, dialkyl sulfosuccinates, alkyl sulfates, sulfurized olefins, polyoxyethylene alkyl ether phosphates, polycarboxylic acids and mono glycerol phosphate, amphoteric surfactants such as alkylpyridinium salts and non-ionic surfactants such as polyoxyethylene alkyl ethers, polyoxyethylene alkyl phenyl ethers, polyoxyethylene alkyl esters, polyoxyethylene alkyl amides, glycerol alkyl esters and sorbitan alkyl esters. Examples include EFKA 1000, 4000, 5000 and 6000 series products from BASF, Tamol series products from Dow, and Solsperse 27,000, 40,000, 44,000, 46,000 and 47,000 from Lubrizol.

The primers of the invention are suitable for applying to plastic substrates (e.g., plastic cards). Suitable plastic substrates (e.g., plastic cards) include those made from polyvinyl chloride acetate, polyvinyl chloride, polyvinylidene dichloride, or any blend of these polymers or copolymers thereof. The substrate is preferably polyvinylchloride. Preferably the substrate is a plastic card. Plastic cards are suitably made from polyvinyl chloride acetate, polyvinyl chloride, polyvinylidene dichloride, or any blend of these polymers or copolymers thereof. Accordingly, the substrate is preferably a plastic card made from polyvinyl chloride acetate, polyvinyl chloride, polyvinylidene dichloride, or any blend of these polymers or copolymers thereof.

The primers of the invention are preferably applied to the plastic core of a card (preferably a payment card). The primers of the invention are applied to the plastic core of the card by any suitable printing or coating method, for example flexographic or screen printing. The cores of payment cards are typically made from polyvinyl chloride acetate, polyvinyl chloride, polyvinylidene dichloride, or any blend of these polymers or copolymers thereof. However, it should be understood that the primer is suitable for coating any plastic core used in the manufacture of payment and financial cards.

Once the substrate (e.g., card core) has been coated with the primers of the invention, they are then printed via any digital printing process as previously outlined. Preferably, the primed core would be printed via a liquid electrophotographic process, such as Hewlett Packard's ‘Indigo’.

In one embodiment, the film weight of the primer coating applied to the first substrate of the invention, after drying, is in the range from 0.1 to 10.0 g m⁻², preferably from 0.1 to 5.0 g m⁻², more preferably from 0.2 to 5.0 g m⁻².

The printed primed core is then thermally laminated to further plastic layers, which may be the same polymer type or a different polymer to the core. This is a process well known to those skilled in the art and typically involves bringing the laminating plastic layers into contact with the printed core and subjecting the plastic layers to temperatures typically from 120 to 160° C., under pressure, although lower and higher temperatures can be used. Pressures typically in excess of 5 psi, and more typically in excess of 10 psi are used. The thermal lamination typically takes anywhere from 0.1 seconds up to 30 minutes.

Without the primer according to the invention, the inventors have found that cards produced via Indigo printing are deficient in lamination bond strengths and also prone to leaching. The primer delivers lamination bond strengths≥5N/cm, ≥7N/cm, ≥10N/cm, 15N/cm, or ≥17N/cm for the final card structure.

### Definitions

Molecular weight—“molecular weight” or “average molecular weight” is a reference to the weight average molecular weight (Mw). The molecular weight is suitably measured by techniques known in the art such as gel permeation chromatography. Preferably, molecular weight is measured by comparison with a polystyrene standard. For instance, molecular weight determination may be conducted on a Hewlett-Packard 1050 Series HPLC system equipped with two GPC Ultrastyragel columns, 103 and 104 Å (5 μm mixed, 300 mm×19 mm, Waters Millipore Corporation, Milford, MA, USA) and THF as mobile phase. The skilled person will appreciate that this definition of molecular weight applies to polymeric materials which typically have a molecular weight distribution.

Particle size/average particle size—the terms “particle size” or “average particle size” refer to the volume distributed median particle diameter (equivalent spherical diameter corresponding to 50% of the volume of all the particles, read on the cumulative distribution curve relating volume % to the diameter of the particles-often referred to as the “D (v,0.5)” value). Particle size is preferably measured by laser light diffraction.

Unless stated otherwise, the term nanoparticle refers to a particle having one dimension of less than 100 nm.

Unless stated otherwise, lamination bond strengths were measured using a JJ Lloyd tensiometer via a T-peel test at a separation speed of 300 mm/min. The lamination bond strengths are reported as N/cm; that is the force required to separate the top film from the primed and printed core for a 1 cm wide strip, e.g., lamination bond strengths reported as N/25 cm is the force required to separate the top film from the primed and printed core for a 25 cm wide strip. Ideally, the minimum bond strength is ≥5N/cm, ≥7N/cm, ≥10N/cm, ≥ 15N/cm, ≥17N/cm or ≥20N/cm.

Unless stated otherwise, viscosity was measured with a Brookfield CAP200 viscometer, equipped with Spindle No. 4, at 50 rpm and a temperature of 19.1° C.

### Leaching

Black inks are very often toned with a reflex (alkali) blue pigment. When carbon black is toned with alkali blue, this allows for more aesthetically appeasing deep shade blacks. However, alkali blue is predominantly a dye and under certain conditions when exposed to moisture/heat and/or high relative humidity (e.g., 50° C./90% RH), as per those of credit card lamination, the blue dye can be seen to leach from the black ink causing the black printed image (in this case HP indigo) to appear significantly more blue, which is unfavorable. The leaching effect can also be evident on fine text, where a blue shadow can be seen outlining the black letters, and also when delaminated, the lamination adhesive will appear blue due to migration on the alkali blue. This leaching problem is addressed by Inventive Examples 1 and 2, which provide dye fixative properties, thus stopping the leaching of the blue dye throughout the print image.

Inventive Example 1 addresses the leaching problem with 0.53 wt % of poly(ethylene imine). In contrast, dye leaching is still observed with Reference Example 5 having only 0.30 wt % poly(ethylene imine). Hence, it will be appreciated by the skilled person that, whilst aqueous primers having less than 0.3 wt % poly(ethylene imine) provide good lamination bond strength, they do not solve the problem of dye leaching.

The present invention has been described in detail, including various embodiments thereof. However, it will be appreciated that those skilled in the art, upon consideration of the present disclosure, may make modifications and/or improvements on this invention that fall within the scope and spirit of the invention.

### EXAMPLES

The invention is further described by the following non-limiting examples which further illustrate the invention, and are not intended, nor should they be interpreted to, limit the scope of the invention.

### Preparation of Flexo and Screen Primers According to the Invention

Primer coatings were prepared according to the formulations laid out in Table 1. The components were added in sequence, with the polymer dispersion first, and blended with a Dispermat high shear mixer.

TABLE 1
Examples of Primer formulations

| | Ref. Ex. 1 | Ref. Ex. 2 | Ref. Ex. 3 | Ref. Ex. 4 | Inv. Ex. 1 | Inv. Ex. 2 | Ref Ex. 5 |
|---|---|---|---|---|---|---|---|
| | (Flexo) | (Screen) | (Flexo) | (Flexo) | (Screen) | (Screen) | (Screen) |
| Component | (wt. %) | (wt. %) | (wt. %) | (wt. %) | (wt. %) | (wt. %) | (wt %) |
| Polyurethane | 73.09 | 72.95 | 75.40 | 69.40 | — | — | — |
| dispersion¹ | | | | | | | |
| EP 124181 T¹⁴ | — | — | — | — | — | 77.4 | — |
| COHESA X-3060² | — | — | 19.10 | 19.10 | — | — | — |
| Neorez 9340³ | — | — | — | — | 93.92 | — | 93.92 |
| Loxanol 6735⁴ | — | — | — | — | 0.53 | 10 | 0.30 |
| Aquaseal 2077⁵ | 22.37 | 22.33 | — | — | — | — | — |
| Tego Foamex 1488⁶ | 0.1 | 0.1 | 0.10 | 0.10 | 0.13 | 0.10 | 0.13 |
| Acticide WR-0268^{7a} | 0.23 | 0.23 | — | — | — | — | — |
| Surfynol 440⁸ | 0.49 | 0.49 | 0.50 | 0.50 | 0.66 | 0.50 | 0.66 |
| Urea | 0.97 | 0.97 | — | — | — | — | — |
| Additol VXW 6388⁹ | 0.32 | 0.5 | 0.30 | 0.30 | — | — | — |
| Trixene BI220¹⁰ | 2.43 | 2.43 | 2.40 | 2.40 | — | — | — |
| Acticide PHE^{7b} | — | — | 0.10 | 0.10 | — | — | — |
| Rheolate 278¹³ | — | — | — | — | — | 2.00 | — |
| Carbodilite SV-02¹¹ | — | — | 2.00 | — | — | — | — |
| Tego Variplus | — | — | — | 8.00 | — | — | — |
| DS50¹² | | | | | — | | |
| Water | — | — | 0.10 | 0.10 | 4.76 | 10.00 | 4.99 |
| Total | 100 | 100 | 100 | 100 | 100 | 100 | 100 |
| Viscosity | 1.76 poise | 3.72 poise | 2.0 poise | 1.75 poise | 17.5 poise | 11.3 poise | 17.5 poise |

¹Anionic Polyurethane dispersion (Alberdingk-Boley; 28% solids);
²Oil-in-water emulsion of an ethylene acrylic acid copolymer (Honeywell; 44.5% solids);
³Non-ionic polyester urethane dispersion (40% solids content; Covestro);
⁴Multifunctional cationic polyethyleneimine crosslinker (BASF);
⁵Waterbased polymer dispersion (Paramelt; 33% solids);
⁶Defoamer (Evonik);
^{7a,7b}Biocide (Thor; ^{7a}35% solids, ^{7b}50% solids);
⁸Surfactant/wetting aid (Evonik);
⁹Polyurethane thickener (Allnex; 37.5% solids);
¹⁰Blocked isocyanate dispersion (Lanxess; 41% solids);
¹¹Carbodiimide crosslinker (Nisshinbo; 40% solids);
¹²Anionic dispersion of PU polyol, ex. Evonik (33% solids);
¹³Polyurethane based thickener (25% solids);
¹⁴Non-anionic acrylic dispersion (40% solids content; Alberdingk-Boley)

Viscosity (poise) was measured with a Brookfield CAP200 viscometer, spindle No. 4, 50 rpm, 19.1° C.

### DESCRIPTION OF EXAMPLES

Reference Example 1: Flexographic PUD primer formulation with blocked isocyanate dispersion crosslinker.

Reference Example 2: Screen printing PUD primer formulation with blocked isocyanate dispersion crosslinker.

Reference Example 3: PUD primer formulation with oil-in-water emulsion of an ethylene acrylic acid copolymer, blocked isocyanate dispersion crosslinker and carbodiimide crosslinker.

Reference Example 4: PUD primer formulation with oil-in-water emulsion of an ethylene acrylic acid copolymer, blocked isocyanate dispersion crosslinker and anionic dispersion of PU polyol.

Inventive Example 1: Screen printing polyester polyurethane primer formulation with 0.53 wt % multifunctional cationic polyethyleneimine crosslinker with improved leaching resistance.

Inventive Example 2: Screen printing acrylic primer formulation with multifunctional cationic polyethyleneimine crosslinker with improved leaching resistance.

Reference Example 5: Screen printing polyester polyurethane primer formulation with 0.3 wt % of multifunctional cationic polyethyleneimine crosslinker.

The primer compositions were applied at 12 gsm (wet) to a PVC based payment card core and then dried to achieve a dry film weight in the range 2.5 to 3.5 gsm (dry). The primed PVC cores were then printed with liquid electrophotographic inks via a HP Indigo Sheet fed press. The primed and printed cores were then thermally laminated under various conditions according to Table 2 to second flexible PVC films. The lamination bond strengths were measured using a JJ Lloyd tensiometer via a T-peel test at a separation speed of 300 mm/min; this is type of testing is well understood by those skilled in the art. The lamination bond strengths are reported as N/cm; that is the force required to separate the top PVC film from the primed and printed core for a 1 cm wide strip.

Adhesion was measured by a tape test using 3M Scotch magic tape. This is placed onto the surface of the printed substrate and rolled 5 times with a 2 kilo roller as per ASTM F2252/52252M-13 (2018). The ink removal is then recorded as a %. All of the inventive examples passed the tape test showing that adhesion was good.

It was observed that without any primer, ink transfer to the vinyl card core was poor and that adhesion, as assessed by a tape test, was also poor.

TABLE 2
Primer performance properties

| | | | | Average |
|---|---|---|---|---|
| | Lamination | Lamination | Lamination | Lamination |
| | Temp. | Pressure | Dwell | Bond Strength |
| Primer | (° C.) | (psi) | Time (sec.) | (N/25 mm) |
| None | 140 | 40 | 20 | <7.0 |
| Ref. Ex. 1 | 140 | 40 | 20 | 27.5 |
| Ref. Ex. 2 | 140 | 40 | 20 | 22.8 |
| Ref. Ex. 3 | 140 | 40 | 20 | 25.5 |
| Ref. Ex. 4 | 140 | 40 | 20 | 23.8 |
| Inv. Ex. 1 | 140 | 40 | 20 | 26 |
| Inv. Ex. 2 | 140 | 40 | 20 | 22 |
| Ref Ex. 5 | 140 | 40 | 20 | 22 |

The results in Table 2 show that the inventive primers produce an improvement in the lamination bond strength compared with the absence of a primer. As shown by the results in Table 3, Inventive Examples 1 and 2 also prevent leaching of the alkali blue dye from indigo black ink.

TABLE 3
Leaching Assessment

| Criteria | Ref. Ex. 1 | Ref. Ex. 2 | Ref. Ex. 3 | Ref. Ex. 4 | Inv. Ex. 1 | Inv. Ex. 2 | Ref. Ex. 5 |
|---|---|---|---|---|---|---|---|
| Delta | 8.40 L | 6.93 L | 8.45 L | 5.96 L | 4.69 | 2.01 | — |
| [DL*] | | | | | | | |
| Delta | 7.82 | 7.47 | 8.11 | 6.49 | 5.52 | 1.98 | — |
| [DEcmc] | | | | | | | |
| Visual Test | Fail | Fail | Fail | Fail | Pass | Pass | Fail |
| | (significant | (significant | (significant | (significant | (slight | (no color | (significant |
| | color | color | color | color | color | change) | color |
| | change) | change) | change) | change) | change) | | change) |

### Test Method for Assessing Leaching

HP indigo ink with alkali blue dye is diluted with Isopar in the ratio a 2:1 ratio. (2-Parts black ink: 1-Part Isopar) and printed using a 40-micron k-bar which deposits a wet coat-weight of about 40 gsm, on a section of HP EPDM Image transfer blanket.

Once coated, the rubber is transferred onto a 160° C. hot plate until all solvent has evaporated, leaving only the ink as a filmic layer. The blanket is then placed ink side down onto pre-primed PVC substrate and impression rolled on the surface using a 2 kg hand roller several times. Prints are then left to fully cool down before further testing is done.

Lamination: inks are printed onto the pre-primed substrate and fully cooled. The areas printed with black ink are cut into strips and laminated to a PVC overlay using a heat sealer (140° C./40 psi/20 seconds). Strips are then cut into 25 mm strips and divided into sections where 1 section is placed into a humidity-controlled oven at 50° C./90% RH/7 days and the remaining sample left in a controlled dark environment. Visual and colour measurements are taken on the humidity aged samples and those stored in the controlled environment.

X-Rite (obtaining LAB & Delta LAB results) Method: Samples are measured for change in color using an X-rite spectrometer, this measures the following parameters to give numerical values indicating color change, where:
Delta E is a standard measurement that quantifies the difference between two colors using a composite of dL*, da* and db*.
Delta E is measured on a scale from 0 to 100, where values≤1.0 are generally not perceptible to the human eye. Values ranging from values 1.0-2.0 are perceptible through close observation. Values between 2.0-10 are perceptible at a glance. Values ranging between 11-49 are colors that are markedly different. Values>49 are considered opposites.
dL* represents the difference in lightness/darkness between the two measurements.
Samples that exhibit less leaching have lower values of Delta E (DEcmc) and Delta L than samples where leaching is observed.

Visual Color Assessment: samples aged in the humidity-controlled oven (as above) are compared visually to unaged samples and assessed. No color change is a pass; slight visual color change is a marginal pass; significant visual color change is considered a fail.

Table 3 exhibits the improvement of the Inventive Examples 1 & 2 in terms of lower measured color change values as well as reduced visual color change. Thus, Examples 1 & 2 are particularly well suited for application where reduction of leaching is desirable.

1-26. (canceled)

27. An aqueous primer composition comprising:
(i) an acrylic dispersion and 1 to 20% (w/w) poly(ethylene imine); or
(ii) a polyester urethane dispersion and 0.5 to 25% (w/w) poly(ethylene imine).

28. The primer composition of claim 1, comprising a polyester urethane dispersion and 0.5 to 25% (w/w) poly(ethylene imine).

29. The primer composition of claim 1, comprising an acrylic dispersion and 1 to 20% (w/w) poly(ethylene imine).

30. The primer composition according to claim 1 wherein the acrylic or polyester urethane dispersion forms greater than 40% (w/w) of the total composition.

31. The primer composition according to claim 2, comprising a polyester urethane dispersion and 0.5 to 15% (w/w) poly(ethylene imine), preferably 0.5 to 8% (w/w) poly(ethylene imine).

32. The primer composition according to claim 3, comprising an acrylic dispersion and 3 to 15% (w/w) poly(ethylene imine).

33. The primer composition according to claim 1 wherein the poly(ethylene imine) has a molecular weight of about 10,000 g/mol to about 50,000 g/mol.

34. The primer composition according to claim 1 wherein the polymer of said dispersion forms, on dry weight, from 2.5 to 99.5% of the primer composition, preferably from 10.0 to 98% of the primer composition, more preferably from 20.0 to 95% of the coating composition.

35. The primer composition according to claim 1, wherein the primer composition has a total solid content of from 5.0 to 60.0% (w/w) and more preferably from 5.0 to 40.0% (w/w).

36. The primer composition according to claim 1, wherein the composition comprises less than 1% (w/w) of calcium nitrate, calcium ammonium nitrate, calcium acetate, calcium chloride or blends thereof, preferably wherein the composition comprises less than 0.5% (w/w) of calcium nitrate, calcium ammonium nitrate, calcium acetate, calcium chloride or blends thereof.

37. The primer composition according to claim 1, wherein the composition comprises 20 to 80% water by mass of the composition, preferably 30 to 70% water by mass of the composition.

38. A method of providing a primed substrate, comprising applying the primer composition of claim 1, and drying the primer.

39. The method of claim 37 wherein the substrate is polyvinylchloride (PVC).

40. A method of providing a primed and printed substrate, comprising applying the primer composition of claim 1, and drying the primer, and subsequently printing one or more ink(s) over the top of the primer and drying the subsequent one or more inks.

41. The method of claim 39, wherein the substrate is polyvinylchloride (PVC).

42. The method of claim 37, wherein the primed and printed substrate is subject to thermal lamination to one or more further plastic layer(s).

43. The method of claim 41, wherein the thermal lamination of further plastic layers is conducted at ≥80° C., preferably ≥100° C.

44. A method for preparing a laminate structure comprising the steps of:
a. applying the primer composition according to claim 1 onto a first substrate;
b. drying the primer;
c. overprinting the primed substrate with one or more digital ink(s);
d. drying the one or more digital ink(s); and
e. laminating a second substrate to the primed and printed first substrate at ≥80° C. to produce a laminated structure.

45. A laminate structure prepared by the method of claim 43.

46. The laminate structure according to claim 44 which is a plastic payment card.

47. Use of an aqueous primer composition for reducing dye leaching in a laminate structure, wherein the aqueous primer composition is as defined in claim 1.
